(19) United States
(12) Patent Application Publication
(10) Pub. No.: US 2005/0006820 A1
(43) Pub. Date: Jan. 13, 2005

(54) Method and apparatus for cooling a sheet-shaped or web-shaped substrate through variation in absorption and/or reflection of heat radiating from the substrate

(75) Inventors: Franz Grajewski, Fuchstal (DE); Erwin Reiber, Karlsfeld (DE); Henning Stieglitz, Munchen (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/863,595

(22) Filed: Jun. 8, 2004

Related U.S. Application Data
(63) Continuation of application No. PCT/EP02/13646, filed on Dec. 3, 2002.

(30) Foreign Application Priority Data
Dec. 13, 2001 (DE) 101 61 168.4

(51) Int. Cl. B29C 35/08

(52) U.S. Cl. 264/405

(57) ABSTRACT

In a method of cooling a sheet-shaped or web-shaped substrate, such as a plastic sheet or a plastic web, the substrate is moved along a cooling path, and heat radiating from the substrate is absorbed and/or reflected along at least one zone of the cooling path to provide a controlled cooling pattern, by using covering elements which are disposed above and/or below the substrate, whereby the zone can be adjusted by the arrangement and/or number of covering elements.

### CROSS-REFERENCES TO RELATED APPLICATIONS

This application is a continuation of prior filed copending PCT International application no. PCT/EP02/13646, filed Dec. 3, 2002, which designated the United States and on which priority is claimed under 35 U.S.C. §120, the disclosure of which is hereby incorporated by reference, and which PCT International application no. PCT/EP02/13646, filed Dec. 3, 2002 claims the priority of German Patent Application, Serial No. 101 61 168.4, filed Dec. 13, 2001, pursuant to 35 U.S.C. 119(a)-(d), the disclosure of which is incorporated herein by reference.

### BACKGROUND OF THE INVENTION

The present invention relates, in general, to a method and apparatus for cooling a sheet-shaped or web-shaped substrate, in particular a plastic sheet or plastic web.

FIG. 9 shows a typical conventional assembly for making sheets or webs of plastic, using an extruder 1 to produce a homogenous melt which is pushed through a sheet die 2 to mold a plastic sheet or web 3. Subsequently, the plastic sheet or web 3 passes through a smoothing device 4 for surface polishing and realizing a homogenous thickness, and is then advanced along a roller track 5 to cool down through exposure to ambient air. Such an assembly runs inefficiently and oftentimes the available installation space is too limited to provide a roller track of sufficient length for the cool-down period.

It is known from German Pat. No. DE 35 50 309 A1 to cool down an extruded thermoplastic web under the application of area pressure by means of a double-band press to a temperature at which smoothing of the surface is then terminated. German Pat. No. DE 198 45 652 A1 describes a device having two pairs of assemblies opposing one another and acting on the surfaces of the material web. Each assembly includes a metal belt which is in contact with the material web and is coolable in an area of contact. The metal belts of the assemblies advance, smooth and cool the material web. As both assemblies carry out smoothing and cooling processes, cooling becomes complicated because of the simultaneous task to effect calibration and smoothing. Thus, the overall device has to be suited individually to the material being processed as well as to the substrate at hand.

German patent publication no. DE 197 52 501 C2 discloses a cooler for cooling plastic sheets or webs which are transported on a roller track when exiting the smoothing device. Separate closed circuits are provided above and below the sheets or webs for circulation of cooling air and extend over a set length of a sheet or web. Air moves in each circuit in a circle by a plurality of fans which are spaced across the width of the sheets or webs, with a cooler being disposed in this circle. Installation of such a cooler with closed circuits above and below the roller track is very complicated and requires large space.

A problem associated with the use of a smoothing device is the occurrence of expansion differences in the product as it advances through the smoothing device. Typically, plastic melt after exiting the sheet die is received in a first nip. As the semi-finished sheet moves through the smoothing device, the surface of sheet is polished and the thickness of the sheet is evened through precise parallelism of the first pair of rolls. The quality of the sheet is hereby influenced by the smoothing device not only in the first nip but also by the looping of the sheet about the following rolls. Depending on the roll temperature, contact time of the sheet on the rolls, sheet width, and type of sheet (amorphous, semi-crystalline), orientations and inherent stress in the plastic sheet are hereby generated that are relevant as far as the desired flatness of the sheet is concerned. As the sheet then cools down, asymmetric temperature profiles are thus encountered which lead to expansion differences across the sheet as areas of the sheet cool down at different times, thereby causing internal stress. One approach to address this problem involves heating of the rolls to even out the asymmetric temperature profile during transition from the molten state to the solid state. However, compensation in this manner is difficult to achieve when semi-crystalline plastics are involved because the rolls need to be cooled down significantly in order to prevent the melt from sticking to the roll surfaces and to prevent crystallization which impairs transparency. Although the internal stress compensation may be enhanced by subsequently maintaining the melt at a temperature, the downside is, however, the occurrence of a thermal aftercrystallization which adversely affects optical properties.

It would therefore be desirable and advantageous to provide an improved method and apparatus of making sheet-shaped or web-shaped extruded products to obviate prior art shortcomings and to avoid inhomogeneities in the material and internal stress in a simple manner.

### SUMMARY OF THE INVENTION

According to one aspect of the present invention, a method of cooling a sheet-shaped or web-shaped substrate, such as a plastic sheet or a plastic web, includes the steps of moving a substrate along a cooling path, and controlling a cooling pattern of the substrate along at least one zone of the cooling path by using covering elements, disposed above and/or below the substrate and impacting heat radiating from the substrate, and by adjusting the zone through arrangement and/or number of the covering elements. Suitably, the zone may hereby be defined by covering elements that absorb heat radiating from the substrate or by covering elements that reflect heat radiating from the substrate.

The present invention resolves prior art problems by exploiting the internal enthalpy of the substrate to influence the cooling process so that the need for external energy sources can be reduced. The absence of active cooling measures simplifies the process considerably, even though the cooling path is still configured long enough to ensure an even cool-down process. Moreover, the cool-down period can be controlled to attain an even cooling of the extrudate so that inhomogeneities in the material and resultant warping of the sheets or webs can be avoided.

The sheet-shaped or web-shaped substrates are subject during their transport along an open and unscreened cooling path to free convection and heat radiation. Both these processes are affected by conditions in the immediate environment of the substrate as well as temperature and flow rate of the surrounding medium, normally air. The cool-down process of the substrate can be controlled by influencing the radiation and re-absorption of heat. This can be implemented through arrangement of covering elements, which absorb and/or reflect heat radiation, above and/or below the substrate. The covering elements are constructed to at least cover the entire width of the cooling path perpendicular to the transport direction to prevent potential edge effects and thus to prevent absorption and/reflection of only partial areas of the substrate that would result in unwanted stress.

Securement of covering elements on one side of the cooling path is in itself sufficient to significantly change the radiation behavior of the substrate. A more even cooling action and thus formation of a more homogenous substrate can be realized by disposing covering elements on both sides above as well as below the cooling path. The areas of absorption and/or reflection can thus be influenced by the arrangement and/or number of covering elements above and/or below the cooling path. The free selection of a number as well as location of the covering elements in relation to the overall length of the cooling path affords great flexibility to suit actual conditions such as, e.g., air temperature and substrate surface temperature.

According to another feature of the present invention, the degree of absorption and/or reflection can be adjusted by changing a distance between the covering elements and the substrate. With a decrease in the distance between substrate and covering element, the substrate cools down at a slower pace and thus less internal stress is able to build up in the material. A similar effect can be realized when the spatial dimension of the zone of absorption and/or reflection is changed. An even simpler adjustment of the absorption and/or reflection to actual conditions involves a measurement of an ambient temperature and/or substrate surface temperature in the zone to provide a temperature value. The spatial dimension of the zone and/or degree of absorption and/or reflection of heat can then be automatically controlled in response to the determined temperature value.

According to another aspect of the present invention, an apparatus for cooling a sheet-shaped or web-shaped substrate, in particular an extruded plastic sheet or plastic web, includes a transport unit for moving a substrate along a transport path to allow the substrate to cool down, and a covering assembly including at least one covering element which is disposed at a distance to the transport unit to define a zone for impact on heat radiating from the substrate, wherein the zone is adjustable in dependence on a disposition of the covering element and/or a number of said covering element provided in the covering assembly. Suitably, the covering element may hereby be constructed to absorb heat or to reflect heat.

Suitably, the covering assembly is constructed to allow adjustment of a distance between the substrate and the covering element.

According to another feature of the present invention, the covering element may be constructed for movement along the transport path so that the zone of reinforced absorption and/or reflection can easily be adjusted to an optimum location. Moreover, the dimension of the covering assembly and thus the degree of absorption and/or reflection can be controlled by adding or removing covering elements.

According to another feature of the present invention, the covering element may include a temperature sensor for measuring, e.g. the ambient temperature or the substrate surface temperature.

According to another feature of the present invention, the covering element can be constructed in the form of a panel which can be moveably secured above or below the cooling path. Advantageously, the covering element may be constructed in the form of a roller blind box having extendable and retractable blinds. Suitably, the roller blind box has opposite sides, with both sides accommodating extendable and retractable blinds. The movement of the blinds is hereby in a direction of the transport path. Suitably, a rail system may be provided for moving the roller blind box. In addition, the provision of an electromotive drive may be suitable for moving the roller blind box.

According to another feature of the present invention, a control unit is provided and so constructed as to automatically control a distance of the covering elements from the substrate, and/or position of the covering elements along the transport path, and/or an area covered by the covering elements, in response to a temperature value determined by the temperature sensor.

The degree of absorption and/or reflection can be influenced by suitably coating the covering elements at a substrate-proximal surface, and or selecting a suitable material for the covering elements. Material and/or coating can hereby vary from covering element to covering element to thereby realize an especially effective cool-down curve as a function of time.

According to another feature of the present invention, the covering element may include shutters disposed at an inclination which can be continuously adjusted in relation to the substrate. In this way, the degree of absorption and/or reflection can be varied between almost 0% and 100%.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a first embodiment of an apparatus for cooling a sheet-shaped or web-shaped substrate in accordance with the present invention;

FIG. 2 is a top view of the apparatus of FIG. 2;

FIG. 3 is a schematic side view of a second embodiment of an apparatus for cooling a sheet-shaped or web-shaped substrate in accordance with the present invention;

FIG. 4 is a top view of the apparatus of FIG. 3;

FIG. 5 is a schematic side view of a third embodiment of an apparatus for cooling a sheet-shaped or web-shaped substrate in accordance with the present invention, illustrating covering elements with closed shutters;

FIG. 6 is a top view of the apparatus of FIG. 5;

FIG. 7 is a side view of the apparatus of FIG. 5 with open shutters;

FIG. 8 is a top view of the apparatus of FIG. 5 with open shutters; and

FIG. 9 is a schematic illustration of a conventional extruder with downstream cooling path.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

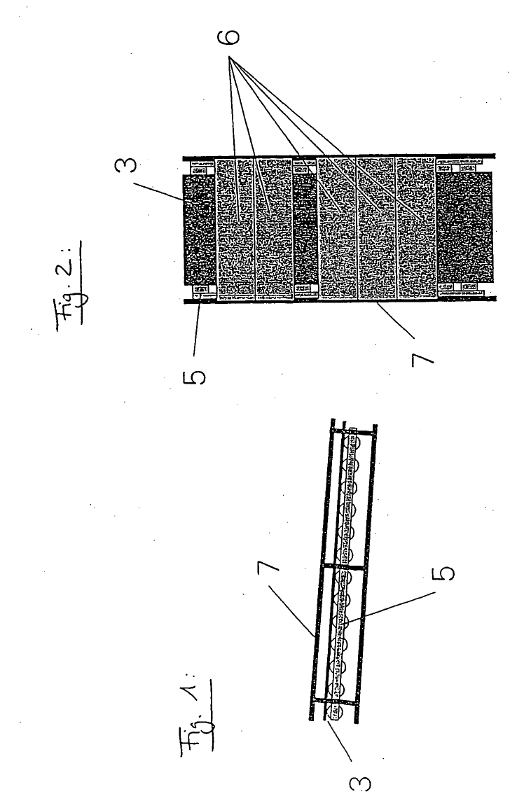

Turning now to the drawing, and in particular to FIG. 1, there is shown a schematic side view of a first embodiment of an apparatus for cooling a sheet-shaped or web-shaped substrate 3 in accordance with the present invention, including a transport unit disposed downstream of a smoothing device (not shown here) and constructed in the form of a roller track 5 for conveying the substrate 3 while allowing the substrate 3 to cool down. Disposed above and below the roller track 5 is a holding device 7 in which covering elements 6 in the form of simple panels are positioned to define a cooling path with one or more zones for controlling the timing pattern of the cool-down process for the substrate 3 by absorbing and/or reflecting heat. In other words, the cooling process of the substrate 3 can be carried out in a controlled manner by using covering elements 6 that absorb heat radiation to cool the substrate 3 or by using covering elements 6 that reflect heat radiation to slow down the cooling of the substrate 3.

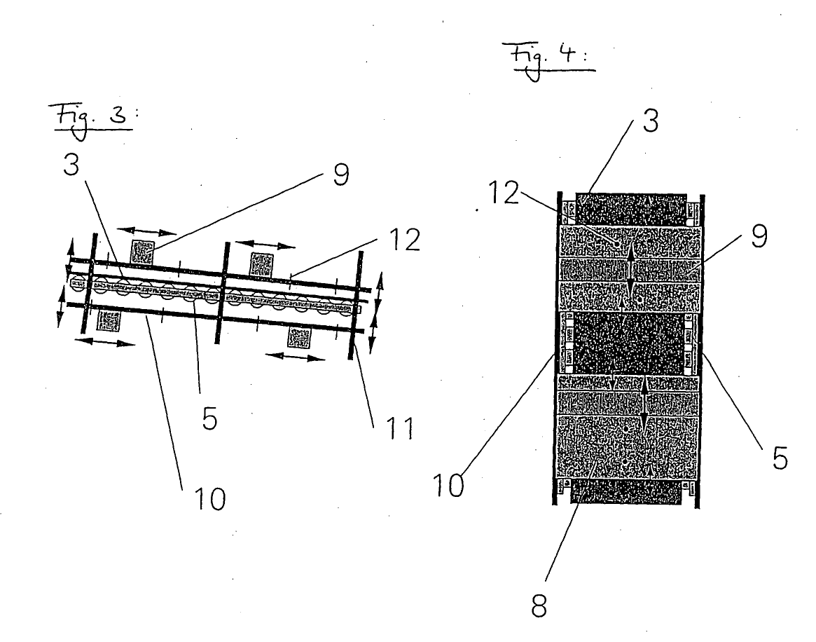

As shown in FIG. 2, which is a top view of the apparatus, the dimension of each zone in which the degree of absorption and/or reflection can be influenced can be varied by adding or removing covering elements 6. Rearranging and/or shifting of individual covering elements 6 affords many options to easily influence the cooling behavior of the substrate 3 in a desired manner.

Persons skilled in the art will understand that the arrangement of covering elements 6 can be suited to the type of substrate 3 at hand, and it is certainly possible to cover the entire cooling path with covering elements 6 of same type or different type. In other words, the cooling path may be covered by covering elements 6 which absorb heat and by covering elements 6 which reflect heat to thereby define different zones of impact on heat radiating from the substrate 3.

FIG. 3 shows a schematic side view of a second embodiment of an apparatus for cooling a sheet-shaped or web-shaped substrate 3 in accordance with the present invention. Parts corresponding with those in FIG. 1 are denoted by identical reference numerals and not explained again. The description below will center on the differences between the embodiments. In this embodiment, provision is made for a covering assembly in the form of roller blind boxes 9 disposed above and below the roller track 5 and mounted to a rail system 10 for movement along the transport path of the roller track 5. The distance between the substrate 3 and the rail system 10 can be changed by a distance adjusting device 11. Temperature sensors 12 are provided to measure the ambient temperature and/or substrate surface temperature so as to suit the operation of the covering assembly in dependence on a determined temperature value ascertained by the temperature sensors 12.

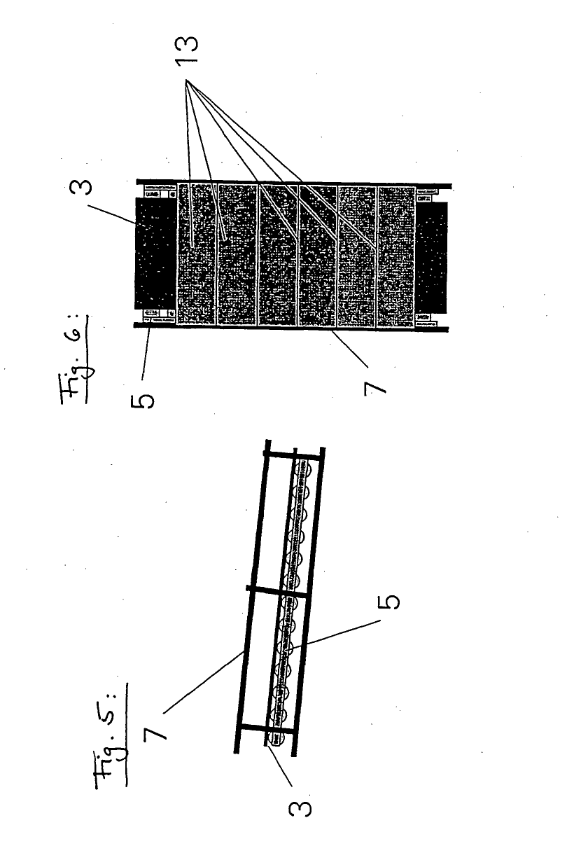

As shown in FIG. 4, the roller blind boxes 9 are constructed to allow a rolling blind 8 to move in and out from both sides thereof. By expanding or decreasing the zone covered by the rolling blinds 8, as they move in or out, and/or by displacement of the roller blind boxes 9 along the rail system 10, and/or adjusting the distance between the substrate 3 and the rolling blinds 8 by means of the distance adjustment device 11, any change in condition in the surroundings can be quickly addressed and reacted to. The provision of the temperature sensors 12, which are attached to the rolling blinds 8, facilitates supervision of the surroundings and allows respective control of the size and position of the covered zone.

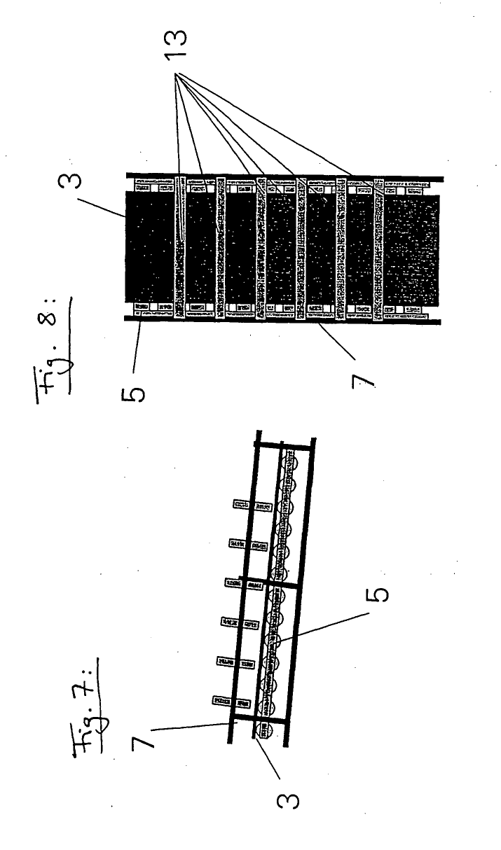

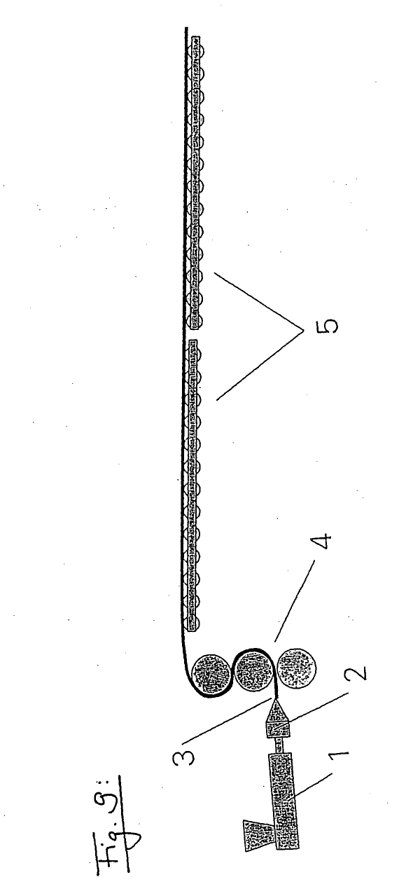

Referring now to FIG. 5, there is shown a schematic side view of a third embodiment of an apparatus for cooling a sheet-shaped or web-shaped substrate 3 in accordance with the present invention. Parts corresponding with those in FIG. 1 are again denoted by identical reference numerals and not explained again. In this embodiment, provision is made for a covering assembly having covering elements in the form of shutters 13. The dimension of the zone in which the degree of absorption and/or reflection is influenced can be adjusted by changing an angle of inclination of the shutters 13 in relation to the substrate 3. FIGS. 5 and 6 show the shutters 13 closed, while FIGS. 7 and 8 show the shutters 13 open at a maximum. Of course, the angle of inclination of the shutters 13 can be randomly selected between these extreme positions in order to best suit the degree of absorption and/or reflection to the prevailing conditions.

Common to all embodiments, is the possibility to suit the number of covering elements to the need at hand. The covering elements may be made of any suitable material capable of absorbing and/or reflecting heat. Examples include covering elements of an aluminum/steel construction, or covering elements coated with black material, such as dyes.

While the invention has been illustrated and described in connection with currently preferred embodiments shown and described in detail, it is not intended to be limited to the details shown since various modifications and structural changes may be made without departing in any way from the spirit of the present invention in order to influence the degree of absorption and/or reflection in certain areas of the roller track 5. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of cooling a sheet-shaped or web-shaped substrate, such as a plastic sheet or plastic web, comprising the steps of:
moving a substrate along a cooling path; and
controlling a cooling pattern of the substrate along at least one zone of the cooling path by using covering elements, disposed above and/or below the substrate and impacting heat radiating from the substrate, and by adjusting the zone through arrangement and/or number of the covering elements.

2. The method of claim 1, wherein the zone is defined by covering elements that absorb heat radiating from the substrate.

3. The method of claim 1, wherein the zone is defined by covering elements that reflect heat radiating from the substrate.

4. The method of claim 1, wherein the degree of impact of the covering elements on the heat radiating from the substrate is adjusted by changing a distance between the covering elements and the substrate.

5. The method of claim 1, wherein a spatial dimension of the zone is changeable.

6. The method of claim 1, further comprising the step of measuring an ambient temperature and/or substrate surface temperature in the zone to provide a temperature value.

7. The method of claim 6, further comprising the step of automatically controlling in response to the temperature value a spatial dimension of the zone and/or degree of impact of the covering elements on the heat radiating from the substrate.

8. Apparatus for cooling a sheet-shaped or web-shaped substrate, in particular extruded plastic sheet or plastic web, comprising:
a transport unit for moving a substrate along a transport path to allow the substrate to cool down; and
a covering assembly including at least one covering element which is disposed at a distance to the transport unit to define a zone for impact on heat radiating from the substrate, wherein the zone is adjustable in dependence on a disposition of the covering element and/or a number of said covering element provided in the covering assembly.

9. The apparatus of claim 8, wherein the covering element is constructed to absorb heat.

10. The apparatus of claim 8, wherein the covering element is constructed to reflect heat.

11. The apparatus of claim 8, wherein the covering element is placed above or below the transport path.

12. The apparatus of claim 8, wherein the covering assembly includes at least two of said covering elements, with one covering element placed below the transport path and one covering element placed above the transport path.

13. The apparatus of claim 8, wherein the covering assembly is constructed to allow adjustment of a distance between the substrate and the covering element.

14. The apparatus of claim 8, wherein the covering element is movable along the transport path.

15. The apparatus of claim 8, wherein the covering assembly is constructed to allow adjustment of a number of covering elements by adding and removing covering elements.

16. The apparatus of claim 8, wherein the covering element includes a temperature sensor.

17. The apparatus of claim 8, wherein the covering element is constructed in the form of a panel.

18. The apparatus of claim 8, wherein the covering element is constructed in the form of a roller blind box having extendable and retractable blinds.

19. The apparatus of claim 18, wherein the roller blind box has opposite sides, each side accommodating a one of said extendable and retractable blinds.

20. The apparatus of claim 18, wherein the blinds move in and out in a direction of the transport path.

21. The apparatus of claim 18, further comprising a rail system for moving the roller blind box.

22. The apparatus of claim 14, further comprising an electromotive drive for moving the roller blind box.

23. The apparatus of claim 16, further comprising a control unit constructed to automatically control a distance of the covering element from the substrate and/or position of the covering element along the transport path and/or an area covered by the covering assembly in response to a temperature value determined by the temperature sensor.

24. The apparatus of claim 8, wherein the covering assembly includes a plurality of said covering element having different intensity with respect to heat radiating from the substrate for adjusting the degree of impact of the covering element on the heat radiation.

25. The apparatus of claim 8, wherein the covering assembly includes a plurality of said covering element coated at a substrate-proximal surface with different intensity with respect to the heat radiating from the substrate for adjusting the degree of impact of the covering element on the heat radiation.

26. The apparatus of claim 8, wherein the covering assembly is constructed to allow control of a course of the cool-down period by adjusting the number of said covering element, and/or coating of the covering element at a substrate-proximal surface with absorbing and/or reflecting coat, and/or material of the covering element, and/or disposition of the covering assembly.

27. The apparatus of claim 8, wherein the covering element is constructed in the form of a shutter with adjustable inclination in relation to the substrate for adjusting the degree of impact of the covering element on heat radiation.
